(19) United States
(12) Patent Application Publication
(10) Pub. No.: US 2007/0124771 A1
(43) Pub. Date: May 31, 2007

(54) Providing an item further to a broadcast

(75) Inventor: Uzi Shvadron, Mitzpe Aviv (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/289,957

(22) Filed: Nov. 30, 2005

(51) Int. Cl. G06F 3/00; G06F 13/00; H04N 5/445; H04N 7/173

(52) U.S. Cl. 725/61; 725/39; 725/87; 725/52

(57) ABSTRACT

A method and system for providing an item (112) further to a broadcast (101) are provided. A user request (108) with a time of a broadcast (101) of an item or a reference to an item is received by a service provider (110). The request (108) includes an indication of the broadcast channel. The service provider (110) determines the item from the time of the request (108), the location from the request was sent (if needed), and the indication of the broadcast channel. The item (112) is provided to a target device (106) of the user, either directly from an item provider (114) or from the service provider (110).

### FIELD OF THE INVENTION

This invention relates to the field of providing an item further to a broadcast. In particular, the invention relates to providing an item in response to a user request during a broadcast of the item or an advertisement for the item.

### BACKGROUND OF THE INVENTION

Impulse purchases in response to a broadcast are an important marketing opportunity. A broadcast on a public broadcast channel may include an item of media content or may include an advertisement for an item. The advertised item may itself be in the form of media content but may also be any other form of product or service.

The term media content is used to include audio and/or visual media items of music, news, documentary programs, television shows, video clips, etc.

People often listen to a song on a public broadcast or watch a television program and would like to obtain a copy of it. This is often a spontaneous reaction at the time of hearing or seeing the media content. Any delay in the process of obtaining the media content is likely to result in fewer people taking the time, or even remembering that they wished to obtain a copy of the media content.

In many cases, people may not know the title of the media content such as a song or a program. This means that it requires an effort to track down the title in order to be able to obtain a copy either from the broadcasting entity or from another provider such as a shop, online seller, etc.

For example, a broadcasting entity may provide copies of the media content online; however, a complex series of operations such as accessing the Internet site of the broadcasting entity and interacting with a choices menu may be required. This will significantly reduce the number of people who order a copy of the media content as people will not take the time or make the effort to do this. In the case where the title is not known, the correct media content may still not be found if the time it was broadcast is remembered incorrectly.

Broadcast advertisements may promote an item in the form of any product or service. Again, people may respond to an advertisement with an immediate intention of purchasing the item. However, if the advertisement required the prospective purchaser to remember details of the item provider or even the item name, the prospective purchaser may not take the trouble to pursue the purchase at a later time.

### SUMMARY OF THE INVENTION

It is an aim of the present invention to provide a simple operation for a user to activate an ordering process for an item in response to the user hearing or seeing a broadcast. The user need not know the title or any information about the item.

According to a first aspect of the present invention there is provided a method for providing an item, comprising: receiving a user request with a time of a broadcast of an item or with a time of a broadcast of a reference to an item, the request including an indication of the broadcast channel; determining the item from the time of the request and the indication of the broadcast channel; and providing the item to the user.

The request may include the indication of the broadcast channel by encoding the indication as the target of the request. This may be achieved by the channel identifier being encoded as the phone number called (or SMS to), the IM address, or the email address. In this way, no input is required from the user and the method can be activated by the touch of a key on a user device (for example, a cellular phone).

The step of determining the item may include determining the location of the user.

The user request may be sent at the time of the broadcast of the item or the reference to the item. Alternatively, the user request may provide a time of the broadcast of the item or the reference to the item.

The method may be carried out by a service provider and includes obtaining the item from an item provider. The item provider may send the item to the user. Alternatively, the item provider may send the item to the service provider that will then forward the item to the user. The service provider may store the item and, on receiving a subsequent user request, search the stored items.

The user request may include an identification of the user. The item may be sent to a target device that is defined by the user. This may be previously specified by the user, for example, at the time the service is set up.

In one embodiment, the item is a media content broadcast on the broadcast channel. In another embodiment, the reference to an item is an advertisement for the item in the form of a product or service.

According to a second aspect of the present invention there is provided a computer program product stored on a computer readable storage medium, comprising computer readable program code means for performing the steps of: receiving a user request with a time of a broadcast of an item or with a time of a broadcast of a reference to an item, the request including an indication of the broadcast channel; determining the item from the time of the request and the indication of the broadcast channel; and providing the item to the user.

According to a third aspect of the present invention there is provided a method of providing a service to a customer over a network, comprising: receiving a user request with a time of a broadcast of an item or with a time of a broadcast of a reference to an item, the request including an indication of the broadcast channel; determining the item from the time of the request and the indication of the broadcast channel; and providing the item to the customer.

According to a fourth aspect of the present invention there is provided a system for providing an item, comprising: a request device for transmitting a user request with a time of a broadcast of an item or with a time of a broadcast of a reference to an item, the request including an indication of the broadcast channel; a service provider operable to receive the user request and including: an item identifier for determining the item from the time of the request and the indication of the broadcast channel; and an item provider for providing the item to the user.

The item identifier may include a location identifier for determining the location of the user.

In one embodiment, the item identifier may determine the item by querying the item provider. The item provider may be in network communication with the service provider. In another embodiment, the service provider and the item provider may be one entity.

The user request may be in the form of one of: a wireless telephone call, a landline telephone call, a text (SMS), an instant message (IM), an email, or any other from in which the item is provided. The provision of an item may be preceded with additional information that is provided to the user in a predefined way (for example, by email), and with an approval stage is so agreed with the user.

The provision of the item may be in the form of one of: a download, an email, a multimedia message, a portable storage medium.

The three elements of channel, time and location uniquely identify a media content that is broadcast. Of these three elements, the channel may need to be provided as an input by the user; however, the elements of time and location can be determined without user input. This has the advantage that a user is only required to enter a single element in the ordering operation.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with the present invention;

FIG. 2 is a block diagram of a service provider in accordance with the present invention;

FIGS. 3A to 3D are block diagrams of various different embodiments of a system of FIG. 1 in accordance with the present invention;

FIG. 4 is a flow diagram of an embodiment of a method of using the present invention;

FIG. 5 is a flow diagram of the method carried out by a service provider in accordance with the present invention; and

FIG. 6 is a flow diagram of another embodiment of a method of using the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention provides a method and system for ordering an item in real-time in response to a broadcast of the item or a reference to the item such as an advertisement. The broadcast channel, time and location uniquely identify the item. The channel may need to be provided manually by a user making a request and the time and location can be determined by the service provider. The ordering operation for the item can be reduced to a spontaneous single touch of a button.

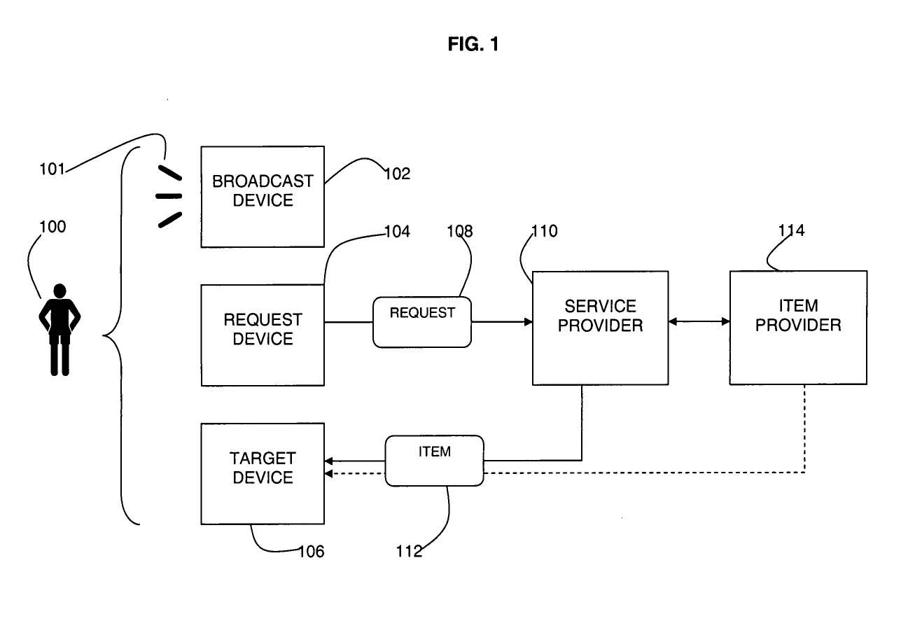

Referring to FIG. 1, a system for providing an item further to a broadcast is shown. A user 100 listens to a broadcast 101 from a broadcast device 102. The broadcast 101 may be from any public broadcasting station on analogue or digital radio and television channels. For example, the broadcast device 102 may be one of: a household radio, a car radio, a portable radio, a television set, a computer with a tuner, a computer receiving broadcasts via the Internet, a handheld computer with wireless communication such as a personal digital assistant or a mobile cellular phone device, and any other form of device through which radio and/or television broadcasts can be received. The broadcast device 102 may not belong to the user 100, for example, the user may be in a public place such as a shop or a restaurant and may hear the broadcast 101.

The user 100 has a request device 104. The request device 104 has the capability to transmit a request 108 to a service provider 110. The request 108 may be in the form of a digital request, or may be converted to a digital request by the service provider 110. The request 108 may be sent by means of a wireless access to the Internet, a wired access to the Internet, a telephone land line, a cellular phone, a text (SMS), an instant message (IM), or an email. The use of a request device 104 which is a mobile device has the advantage that the user 100 can be on the move away from a computer allowing a spontaneous request to be made upon hearing the broadcast. For example, the request device 104 may be a cellular phone or a PDA (personal digital assistant). The request device 104 may be the broadcast device 102 itself, if it has such a capability.

The user also has a target device 106 which is a device at which the user would like to receive the item 112. The target device 106 may be any form of device which can receive an item. In one embodiment, the item 112 is a media content and the media content may be sent by email, by download on a direct connection to a device by providing a link to a download site, or delivery of a storage medium such as a CD-ROM by mail. In some cases, the target device 106 may be the same as the request device 104 and/or the broadcast device 102. Other forms of items such as products or services may be sent or provided to the user via other means.

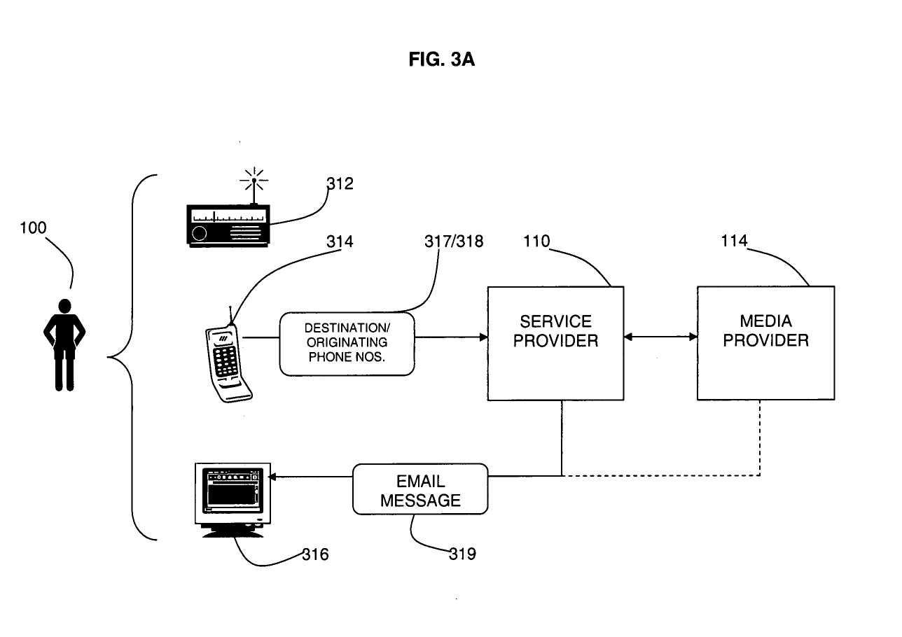

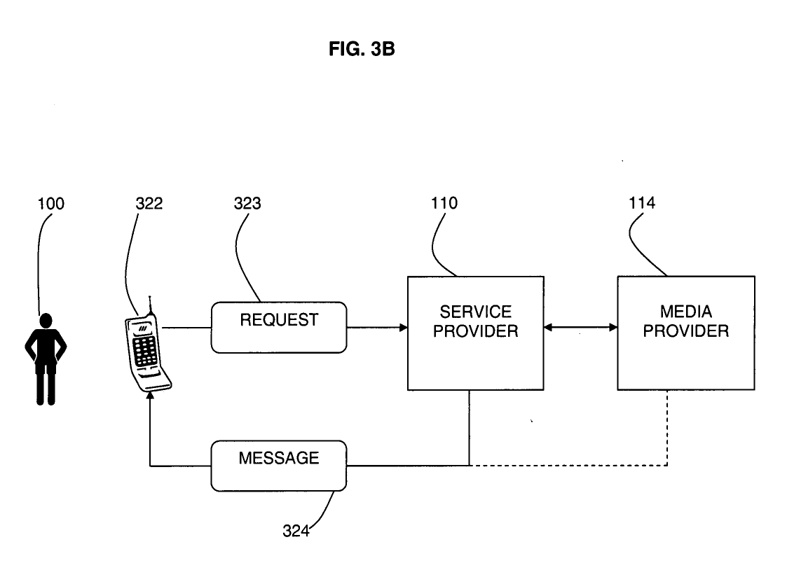

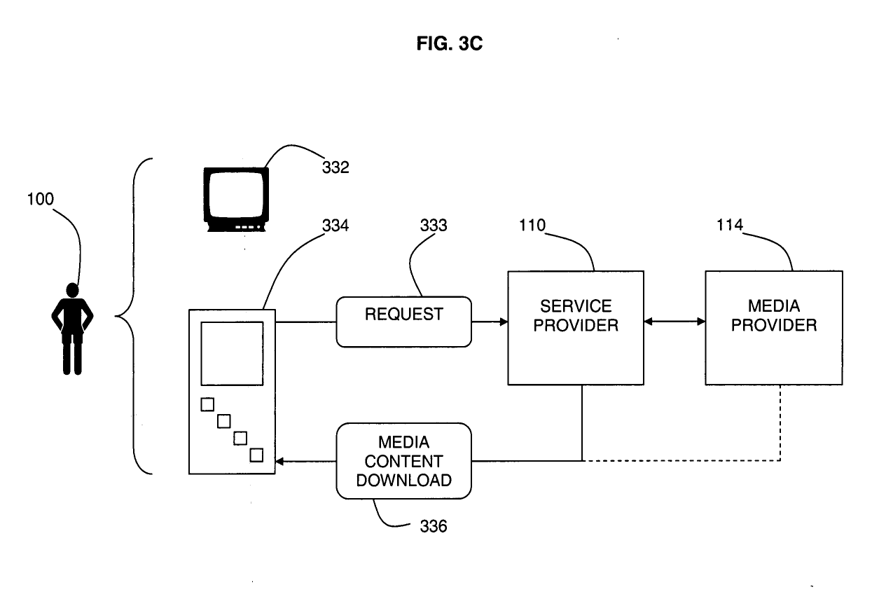

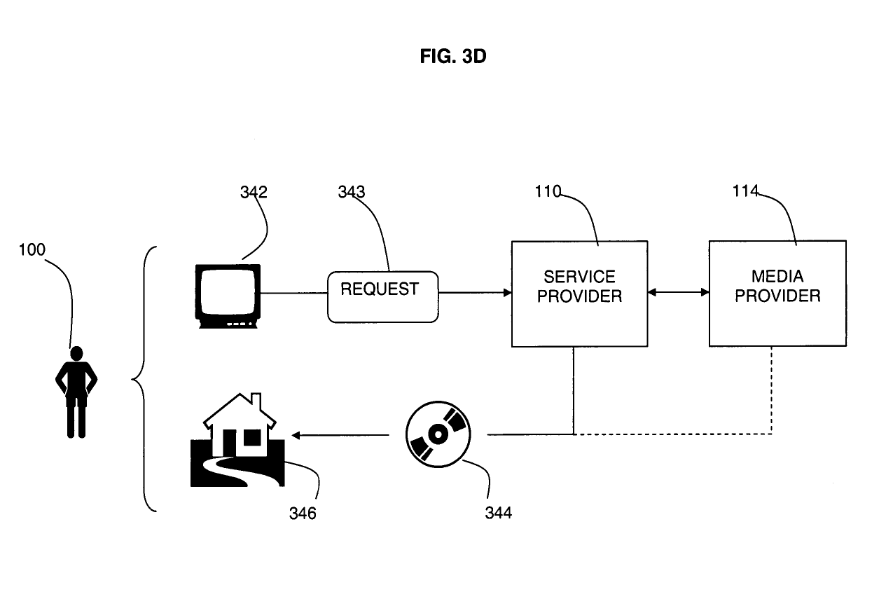

It will be appreciated that there are many different combinations of the three devices 102, 104, 106 and some embodiments are described below as examples with reference to FIGS. 3A to 3D. In one embodiment, a single device may provide the capabilities of all three devices 102, 104, 106. For example, a device such as a PDA, a smart phone, a portable media player (such as an iPOD, Trade Mark of Apple Computer, Inc.), a computer, or a set top television box. A single device includes the function of receiving the broadcast (e.g. by a frequency tuner or via the Internet), communication means to send a request (e.g. by telephone communication, by message, etc.), and media content receiving means (e.g. by email or by direct download via the Internet). Any device with all these functions may be used to combine the three devices.

The request device 104 transmits three parameters to the service provider 110: an identification of the broadcast channel, the time, and the location from which the broadcast was received. In some instances the location may not be required. From these three parameters the service provider 110 can uniquely identify the item.

The broadcast channel can be identified by the channel frequency, or by its name. This can be done by various methods. In one embodiment, the channel information can be encoded in the destination phone number that is called by the request device 104. For example, *88FM may be a phone number for contacting the service provider for an item broadcast on the channel with this name. The destination phone number can be stored in a quick dial memory of a cellular phone or home phone to enable a user to immediately dial if an item or a reference to an item is broadcast which the user wishes to purchase.

The time can be determined by the service provider as all communications can be recorded against a clock by the service provider. The time is recorded a the time the request was sent or received. Alternatively, the user may send another time/date and location information from which the item can be determined.

The location can be determined by a wireless access point used by a wireless device such as a cellular phone. A cellular phone has the cell information from which the cellular phone is activated. A landline telephone location can be determined from the area code and number of a caller. The location information can be used by the service provider to identify the item. The location is needed as radio channels may broadcast in different frequencies in different areas and an overlap may occur. Local radio channels often use the same frequency in different areas. In some embodiments, the location information may not be required.

A user 100 has a user identifier which is sent with the digital request 108 to the service provider 110. The user identifier may be provided by the originating telephone number of the request device 104. The user identifier may be used to access a predefined agreement between the user 100 and the service provider 110 providing payment details and designating a target device 106 for receiving the item 112.

The service provider 110 receives the request 108 from the request device 104, via an Internet communication, a telephone communication, or other message communication. A request device 104 may user a protocol that contains the relevant information. In the case of a protocol, the user 100 would only be requested to enter manually the channel information. In the case of a telephone communication, the service provider 110 may use an automatic voice response system to interact with the user 100 and confirm the request acceptance.

The service provider 110 determines what the item is that is requested by the user 100 and obtains the item 112 for transmitting to the target device 106 of the user. The service provider 114 may obtain the item from an item provider 114. The item provider 114 may be a media provider which may be the broadcasting entity or another source of media content such as a database, an online media store, a library, etc. The service provider 110 determines the best source of the item.

An item provider 114 may send the item 112 directly to the target device 106 based on information provided by the service provider 110 (shown in broken lines in FIG. 1). Alternatively, the item provider 114 may send the item 112 to the service provider 110 and the service provider 110 forwards the item to the target device 106. In the latter case, if the item is media content, the service provider 110 may cache the media content for subsequent requests by other users.

The predetermined agreement with the user indicates the target device 106 to be used for a user 100 and may include a step of approval from the user 100 prior to the actual transmission or sending of the item 112.

In one embodiment, an item 112 in the form of media content is sent to the target device 106 by email. This enables the service provider 110 to enable the user 100 to approve the request and to make sure that the sent media content is the desired one. This can be achieved by sending only a sample in an initial email and enabling the user to download or request the full content, if approved. This also enables the service provider 110 to offer more content based on the context, for example, the type of media required, other similar content, user requests history, other users' requests, etc.

The service provider 110 and the item provider 114 may be provided by a single entity.

In the case where the service provider 110 is separate to an item provider 114 in the form of a media provider, the service provider 110 may store media content previously provided from one or more media providers. When receiving a request 108, the service provider 110 may query the media provider for the content ID (based on the request information) and then search its own store of media content and, if available, send the media content direct to the target device 106. If the media content is not in the store, the service provider 110 may then obtain a copy of the media content from a media provider.

A media content may be broadcast 101 in order for people to use the service to obtain copies of the media content. On the other hand, the broadcast may take place regardless of the existence of the service which may be provided independently of the broadcasting entity.

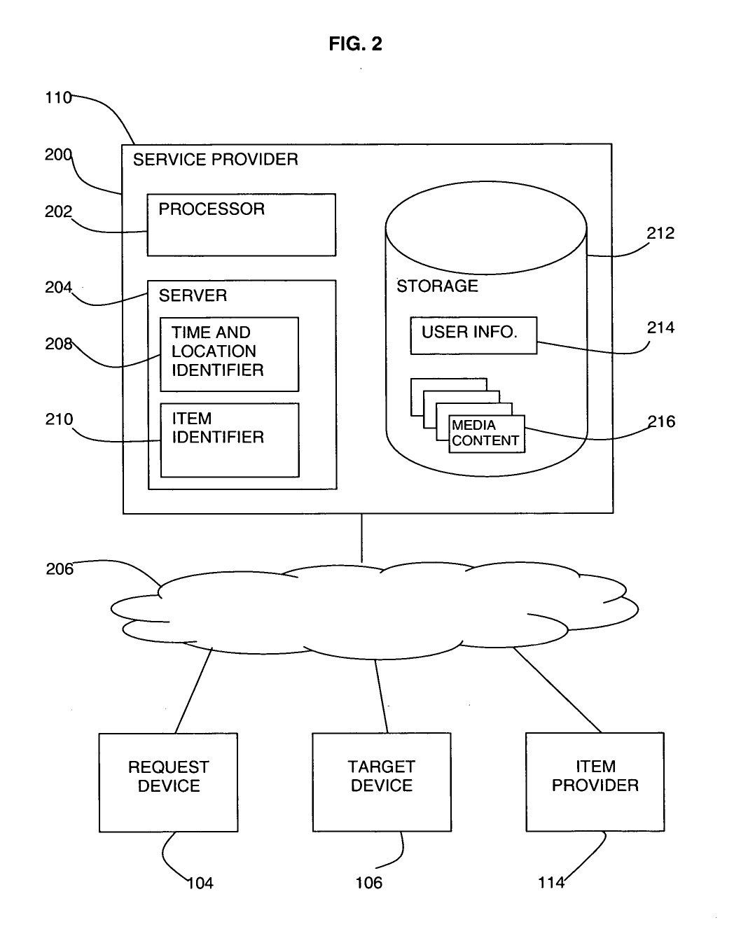

Referring to FIG. 2, a more detailed representation of the service provider 110 is shown. The service provider is implemented as a computer system 200.

The computer system 200 is suitable for storing and/or executing program code and includes at least one processor 202 couple directly or indirectly to memory elements through a system bus. The memory elements can include local memory employed during actual execution or the program code, bulk storage, and cache memories which provide temporary storage of at least some program code in order to reduce the number of times code must be retrieved from bulk storage during execution.

Input/output devices or I/O devices (including but not limited to keyboards, displays, pointing devices, etc.) can be coupled to the system either directly or through intervening I/O controllers.

The computing system 200 may operate in a networked environment using logical connections to one or more remote computers via a network adapter. Network adapters may be coupled to the system to enable the data processing system to become coupled to other data processing systems, databases, or storage devices through intervening private or public networks. Modems, cable modem and Ethernet cards are just a few of the currently available types of network adapters.

The computer system 200 includes server application software 204 to carry out the service on behalf of clients via a network 206 such as the Internet. The clients are in the form of the request devices 104 and target devices 106. The computer system 200 may also be in communication via the network 206 with one or more media providers 114.

The server 204 includes a time and location identifier 208 for determining the time and location of a received request from a request device 104 and an item content identifier 210 for determining the item given the channel, time and location. The item identifier 210 for determining item may use references such as play list guides accessed via the network 206 to the broadcast provider.

The time is determined by the time the request 108 was sent from the user's request device 104, unless a specific time is provided in the content of the request 108. The location from which the broadcast was received is determined by the service provider 110, unless a specific location is provided in the content of the request 108.

In the case of a cellular service provider, the location is determined by the cell from which the call is received. A landline phone service provider would determine the location based on the area code from which the call is received. When a request 108 is sent over the Internet via an SMS or IM, the request content from the request device 104 contains the location information.

The item provider 114 provides an item identifier to the service provider 110 in order to enable the service provider 110 to locate the item in its storage 212.

The computer system 200 includes storage 212 in which predetermined user information 214 can be stored. Additionally, items 216 in the form of media content obtained from item providers 114 in the form of media providers can be stored in the storage 212 of the computer system 200 and supplied to the target devices 106.

Several embodiments of the system are now described with reference to FIGS. 3A to 3D using different forms of broadcast device 102, request device 104 and target device 106 in combined and separate forms. Combination of the embodiments may be used. In these embodiments, the item is a media content provided by an item provider in the form of a media provider 114. In each of FIGS. 3A to 3D, the user 100, service provider 110 and media provider 114 are shown.

FIG. 3A shows an embodiment with a broadcast device in the form of an analogue radio 312. A request device is in the form of a cellular phone 314 by means of which the user 100 sends a request to the service provider 110. The request may identify the channel by using a designated destination phone number 317 and the request may identify the user 100 by the originating phone number 318. The target device is in the form of a home computer 316 and the media content is received at the target device by means of an email message 319.

FIG. 3B shows an embodiment in which the broadcast device, the request device, and the target device are combined in the form of a smart cellular phone 322. The broadcast may be by means of wireless Internet access. The request 323 may be made using the phone to dial a destination telephone number or may be by means of a text (SMS) or instant message. The cell in which the cellular phone 322 is operating will provide location information to the service provider 110. The cellular phone 322 provides a target device by receiving the media content via a download from the wireless Internet connection or by multimedia message 324.

FIG. 3C shows an embodiment in which the broadcast device is a television 332. The television may be digital or analogue. The request device and the target device are combined in a PDA 334 with wireless Internet access to send a request 333 and to receive a download of the media content 336. The request 333 may be sent by a protocol from the PDA 334 in response to an on screen user interface option to order the media content.

FIG. 3D shows an embodiment in which the broadcast device is a digital television 342 in which an interactive connection enables a user to activate an order during the broadcast of a program. The order request 343 is sent to the service provider 110 via a digital cable back channel of the television 342. In this embodiment, the user agreement with the service provider 110 specifies that the target device is to received the media content by CD-ROM 344 by mail to the user's address 346.

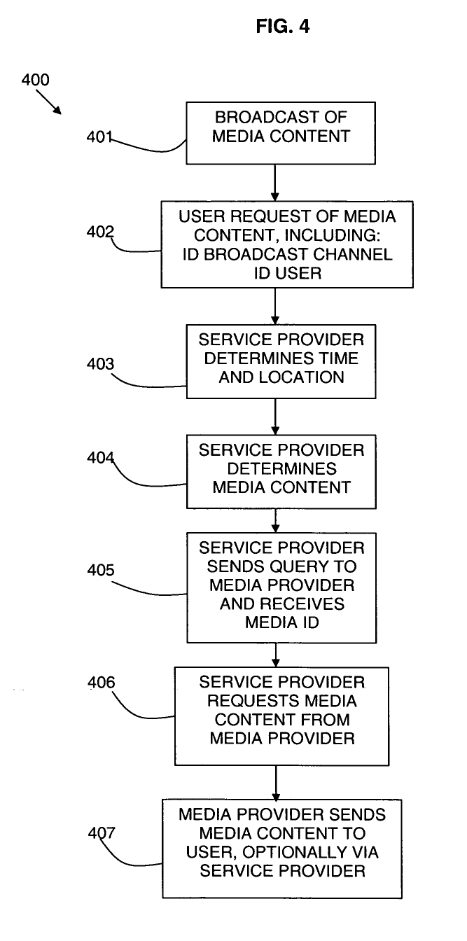

Referring to FIG. 4, a flow diagram 400 is shown of a general method of obtaining media content further to a broadcast. The media content is broadcast 401 and a user requests 402 the media content from a service provider. The request includes an identification of the broadcast channel and an identification of the user.

The service provider determines 403 the time and location of the request and uses this information together with the broadcast channel supplied in the request to determine 404 the media content required by the user. This is done by sending a query 405 to the media provider and receiving a media content identifier.

The service provider requests 406 the media content from a media provider. The media provider sends 407 the media content to the user, optionally via the service provider.

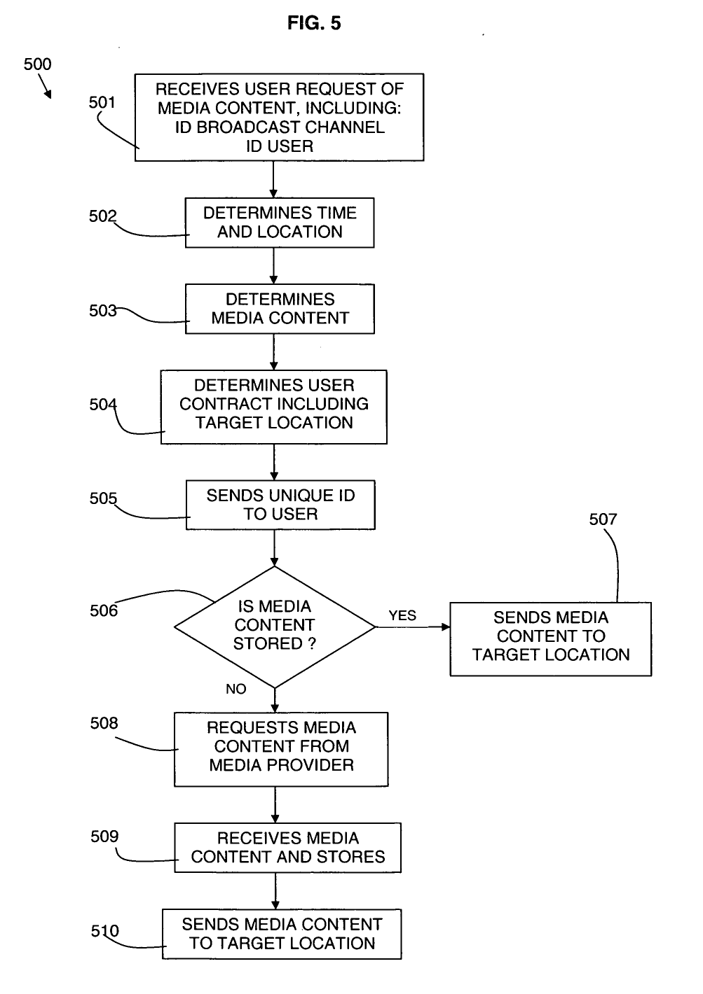

FIG. 5 shows a flow diagram 500 of an embodiment of the process carried out by the service provider. The service provider receives 501 the user request including the identification of the broadcast channel and the user. The service provider determines 502 the time and location of the request and uses this information together with the broadcast channel to determine 503 the media content required. This is done by sending a query to the media provider.

The service provider accesses the user contract agreement using the user identification and ascertains the target device location 504. The service provider sends 505 a unique identifier to the user for the request.

The service provider then determines 506 is the media content is stored in the service provider's storage. If so, the service provider can send 507 the media content to the target device. If not, the service provider requests 508 the media content from a media provider. The service provider receives 509 the media content and stores it in its storage and sends 510 the media content to the target device.

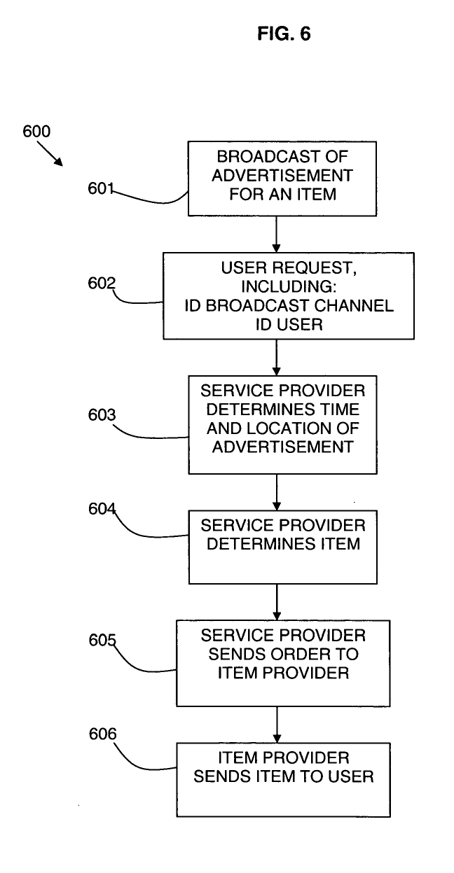

Referring to FIG. 6, a flow diagram 600 is shown of a method of ordering an item further to a broadcast advertisement. An advertisement is broadcast 601 and a user sends a request 602 including an identifier of the broadcast channel and a user ID.

The service provider determines 603 the time and location of the advertisement and determines 604 the item advertised.

The service provider sends an order 605 to an item provider, which may be the advertiser or another agent. The service provider will have a service agreement with the user including payment details and delivery details. The item provider sends 606 the item to the user.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

The present invention may be provided as a service to a customer over a network. In particular, the service may provide media content in response to a request which identifies the broadcast channel and which is made at the time of the broadcast.

Improvements and modifications can be made to the foregoing without departing from the scope of the present invention.

We claim:

1. A method for providing an item, comprising:
receiving a user request with a time of a broadcast of an item or with a time of a broadcast of a reference to an item, the request including an indication of the broadcast channel;
determining the item from the time of the request and the indication of the broadcast channel; and
providing the item to the user.

2. A method as claimed in claim 1, wherein the request includes the indication of the broadcast channel by encoding the indication as the target of the request.

3. A method as claimed in claim 1, wherein the step of determining the item includes determining the location of the user.

4. A method as claimed in claim 1, wherein the user request is sent at the time of the broadcast of the item or the reference to the item.

5. A method as claimed in claim 1, wherein the user request provides a time of the broadcast of the item or the reference to the item.

6. A method as claimed in claim 1, wherein the method is carried out by a service provider and includes obtaining the item from an item provider.

7. A method as claimed in claim 4, wherein the service provider stores the item and, on receiving a subsequent user request, searches the stored items.

8. A method as claimed in claim 1, wherein the user request includes an identification of the user.

9. A method as claimed in claim 1, wherein the item is a media content.

10. A method as claimed in claim 1, wherein the reference to an item is an advertisement for the item.

11. A computer program product stored on a computer readable storage medium, comprising computer readable program code means for performing the steps of:
receiving a user request with a time of a broadcast of an item or with a time of a broadcast of a reference to an item, the request including an indication of the broadcast channel;
determining the item from the time of the request and the indication of the broadcast channel; and
providing the item to the user.

12. A method of providing a service to a customer over a network, comprising:
receiving a user request with a time of a broadcast of an item or with a time of a broadcast of a reference to an item, the request including an indication of the broadcast channel;
determining the item from the time of the request and the indication of the broadcast channel; and
providing the item to the customer.

13. A system for providing an item, comprising:
a request device for transmitting a user request with a time of a broadcast of an item or with a time of a broadcast of a reference to an item, the request including an indication of the broadcast channel;
a service provider operable to receive the user request and including:
an item identifier for determining the item from the time of the request and the indication of the broadcast channel; and
an item provider for providing the item to the user.

14. A system as claimed in claim 13, wherein the indication of the broadcast channel is encoded in the target of the request.

15. A system as claimed in claim 13, wherein the item identifier includes a location identifier for determining the location of the user.

16. A system as claimed in claim 13, wherein the item identifier determines the item by querying the item provider.

17. A system as claimed in claim 13, wherein the service provider and the item provider are one entity.

18. A system as claimed in claim 13, wherein the item provider is in network communication with the service provider.

19. A system as claimed in claim 13, wherein the user request is in the form of one of: a wireless telephone call, a landline telephone call, a text (SMS), an instant message (IM), or an email.

20. A system as claimed in claim 13, wherein the provision of the item is in the form of one of: a download, an email, a multimedia message, a portable storage medium.
